(19) United States
(12) Patent Application Publication
(10) Pub. No.: US 2020/0347891 A1
(43) Pub. Date: Nov. 5, 2020

(54) METHOD FOR ASSEMBLING A TRIPOD ROLLER, TRIPOD ROLLER, AND CONSTANT VELOCITY JOINT HAVING THE TRIPOD ROLLER

(71) Applicant: Schaeffler Technologies AG & Co. KG, Herzogenaurach (DE)

(72) Inventors: Xavier Mehul, Rosheim (FR); Christophe Walliser, Haguenau (FR); Jean-Philippe Dietrich, Drusenheim (FR); Eric Moschler, Haguenau (FR); Gabriel Dalstein, La Petite Pierre (FR)

(73) Assignee: Schaeffler Technologies AG & Co. KG, Herzogenaurach (DE)

(21) Appl. No.: 16/962,522

(22) PCT Filed: Jan. 11, 2019
(86) PCT No.: PCT/DE2019/100020

§ 371 Date: Jul. 16, 2020

(30) Foreign Application Priority Data
Jan. 17, 2018 (DE) 10 2018 100 959.3

(51) Int. Cl. F16D 3/205

(52) U.S. Cl. CPC F16D 3/2055; F16D 2003/2026; F16D 2250/0084

(57) ABSTRACT

Constant velocity joints are used in vehicles to transmit a torque from the drive train to the driven wheels and at the same time to allow bending movements to allow the vehicle to drive around bends or to dip the chassis relative to the driven wheels. An outer ring of a tripod roller has flanges which retain rollers and retain an inner ring. During assembly, the inner ring is cooled such that its diameter is reduced such that it can be moved into position axially without interference from the flange. Once the parts return to the same temperature, the inner ring and rollers are retained.

### CROSS-REFERENCE TO RELATED APPLICATIONS

This application is the U.S. National Phase of PCT Appln. No. PCT/DE2019/100020 filed Jan. 11, 2019, which claims priority to DE 10 2018 100 959.3 filed Jan. 17, 2018, the entire disclosures of which are incorporated by reference herein.

### TECHNICAL FIELD

The disclosure relates to a method for assembling a tripod roller. The disclosure further relates to the tripod roller and a constant velocity joint having the tripod roller.

### BACKGROUND

Constant velocity joints are used in vehicles to transmit a torque from the drive train to the driven wheels and at the same time to allow bending movements to allow the vehicle to drive around bends or to dip the chassis relative to the driven wheels.

In one widespread design, these constant velocity joints comprise an articulated bell and a star, on each of which a tripod roller is placed, which on the one hand transmits the torque in the direction of rotation and on the other hand can be moved along the articulated bell or can roll with little friction.

An example of such a constant velocity joint is shown in the published patent application DE 44 39 965 A1. The document discloses a tripod unit having three tripod rollers, each of the tripod rollers having an inner ring and an outer ring. A large number of rolling elements, in particular needles, are arranged between the rings, so that the inner ring and outer ring can roll relative to one another.

### SUMMARY

It is desirable to propose a method for assembling a tripod roller, a tripod roller, and a constant velocity joint having the tripod roller, so that the tripod roller can be produced inexpensively.

A method for assembling a tripod roller is particularly suitable and/or designed for a constant velocity joint, in particular for a tripod joint. The constant velocity joint is designed in particular as a constant velocity slip joint. In particular, the constant velocity joint is designed as a homokinetic joint for uniform angular velocity and torque transmission from one shaft to a second shaft attached at an angle thereto. The constant velocity joint is particularly preferably designed as a transmission joint for transmitting a drive torque from an engine to steered wheels of a vehicle. In particular, the constant velocity joint is arranged between an axle drive and a drive shaft. The constant velocity joint has as a first joint partner a tripod star with three pins which extend in the radial direction to an axis of the tripod star. Such a tripod roller is positioned on the pin. The tripod star engages in an articulated bell as the second joint partner, the articulated bell having three elongate recesses running in the axial direction to the second joint partner, in which the three tripod rollers can move axially to the second joint partner.

The tripod roller has an outer ring, wherein the outer ring provides an outer raceway. The outer raceway is designed in particular as a cylindrical surface area. The tripod roller also has an inner ring with an inner raceway, the inner raceway and outer raceway being arranged concentrically and/or coaxially with respect to one another. The inner raceway is designed in particular as a cylindrical surface area. In particular, the inner raceway and the outer raceway define a tripod roller axis. In a longitudinal section along the tripod roller axis, the outer ring preferably has a spherical and/or spherical segment-like outer side. The inner ring and the outer ring are each designed as a running ring. The running rings are preferably made of a metallic material, in particular steel.

A rolling element space is formed between the running rings, in particular between the inner ring and the outer ring, in particular between the inner raceway and the outer raceway.

The tripod roller has a plurality of rolling elements, the rolling elements being arranged in the rolling element space. In particular, the rolling elements are designed as rollers, in particular as needles. The inner raceway and outer raceway and/or inner ring and outer ring can move relative to one another via the rolling elements. In particular, the running rings are mounted on one another via the rolling elements.

The tripod roller has a first and a second edge. The flanges limit the rolling element space in the axial direction to the tripod roller axis. Alternatively or in addition, the flanges form an axial run-up for the rolling elements. Each of the flanges defines a flange diameter. The flange diameters can be the same or different. Depending on the specific configuration, the flange diameters can be designed as an outer diameter or as an inner diameter.

Both flanges are assigned to one of the running rings, this running ring forming a flange ring and the other running ring forming a thrust ring. The raceway for the rolling elements from the thrust ring defines a raceway diameter.

The flanges may be integrally formed on the flange ring, so that the flange ring is U-shaped in a longitudinal section. The raceway diameter of the thrust ring may overlap both flange diameters at least in the form of an interference fit. The thrust ring between the flanges is thus held in a form-fitting and/or captive manner with respect to an axial direction to the tripod roller axis. Alternatively or in addition, the flanges form an axial run-up for the thrust ring in both axial directions.

The running rings may be assembled one inside the other, the running rings having a temperature difference during the assembly process. In particular, the temperature difference and the structural design of the running rings are adapted to one another in such a way that the running rings can be assembled into one another without collision or at least non-destructively during assembly. The assembly is preferably carried out by axially pushing the running rings together. The rolling elements are inserted into the race or running rings before assembly.

The assembled tripod roller does not allow disassembly of the running rings, since these are designed to be at least an interference fit. On the other hand, the one-piece design of the flanges with the flange is a particularly cost-effective solution for the production of the tripod roller in terms of manufacture, which also has very good functionality. In order to enable this constructive solution, which cannot be implemented per se, it is proposed that the running rings have a temperature difference during the assembly process. In principle, it is known that in particular metallic bodies contract when the temperature drops and expand when the temperature rises. This effect, which is known per se, is used in the method for assembling the tripod roller. The fact that a temperature difference between the running rings is maintained during the assembly process means that the inner ring contracts and the outer ring expands, so that the running rings can be fitted into one another.

In a preferred development, the temperature difference is more than 100° C., preferably more than 150° C. This temperature difference ensures that the change in contour of at least one of the running rings is sufficient so that assembly can take place.

In a preferred implementation, the inner ring is cooled and/or the outer ring is heated to produce the temperature difference. A particularly practical variant provides that the inner ring is cooled, and the outer ring is at ambient temperature or is heated. The cooling is carried out, for example, by treating the inner ring with liquid nitrogen, which has a boiling temperature of −194° C. The aforementioned temperature difference of at least 100° C., preferably at least 150° C. in an industrial environment can also be achieved in series production.

A tripod roller has the inner ring and the outer ring and the plurality of rolling elements as described above. Furthermore, the tripod roller has the flanges, as also were described above. The relationship between the raceway diameter and the two flange diameters is also designed as described above.

The difference between the raceway diameter and at least one of the flange diameters may be chosen such that the running rings are fitted into one another if the running rings have the temperature difference as described above. In terms of construction, the tripod roller is designed in such a way that the running rings can be fitted into one another when the temperature difference is applied.

One of the flanges may be designed as a support flange and the other flange may be designed as an assembly flange, the difference in diameter between the raceway diameter and the flange diameter of the support flange being greater than the difference in diameter between the raceway diameter and the flange diameter of the assembly flange. The running ring to be assembled is pushed over the assembly edge because the difference in diameter is very small. The assembly flange thus defines an assembly side.

The diameter difference, the interference fit, etc., are preferably considered at an ambient temperature of 20° C., for example.

The flange ring may be designed as the outer ring and/or the thrust ring as the inner ring. Thus, the flanges are opened radially inwards to the tripod roller axis. The thrust ring as an inner ring is arranged between the flanges and runs axially thereagainst. The free inner diameter of the flanges forms the flange diameter. The inner raceway of the thrust ring designed as an inner ring forms the raceway diameter. The free inner diameter of the flanges is made smaller than the raceway diameter of the thrust ring.

In the event that the flanges are designed as a support flange and an assembly flange, the free inner diameter of the support flange is smaller than the free inner diameter of the assembly edge. With regard to the inner diameter, the assembly flange edge is adapted to the raceway diameter of the thrust ring in such a way that, given the temperature difference, the inner diameter of the assembly flange is greater than or equal to the raceway diameter.

The thrust ring has at least one axial side, through which the thrust ring is inserted into the flange ring, the maximum diameter of the raceway diameter. The thrust ring, in particular the inner ring, may be designed without a flange. Specifically, the maximum diameter of the thrust ring, in particular the inner ring, is defined by the raceway diameter. The thrust ring, in particular the inner ring with the axial side surfaces may run or can run toward both flanges during operation.

A constant velocity joint has at least one tripod roller, as described above. The constant velocity joint has as a joint partner a tripod star, which has three pins oriented in the radial direction with respect to the joint partner, on each of which a tripod roller is arranged, as described above. The other joint partner, on the other hand, is designed as a bell, which has three elongated recesses into which the tripod rollers are inserted. In particular, the constant velocity joint is designed as described above.

### BRIEF DESCRIPTION OF THE DRAWINGS

Further features, advantages and effects result from the following description of a preferred exemplary embodiment and the attached figures. In these:

FIG. 1 shows a schematic block diagram of a constant velocity joint;

FIGS. 2a-d show schematic representations of the method for assembling the tripod roller for the constant velocity joint in FIG. 1;

FIGS. 3a-d show schematic representations of the method for assembling an alternative tripod roller for the constant velocity joint in FIG. 1.

### DETAILED DESCRIPTION

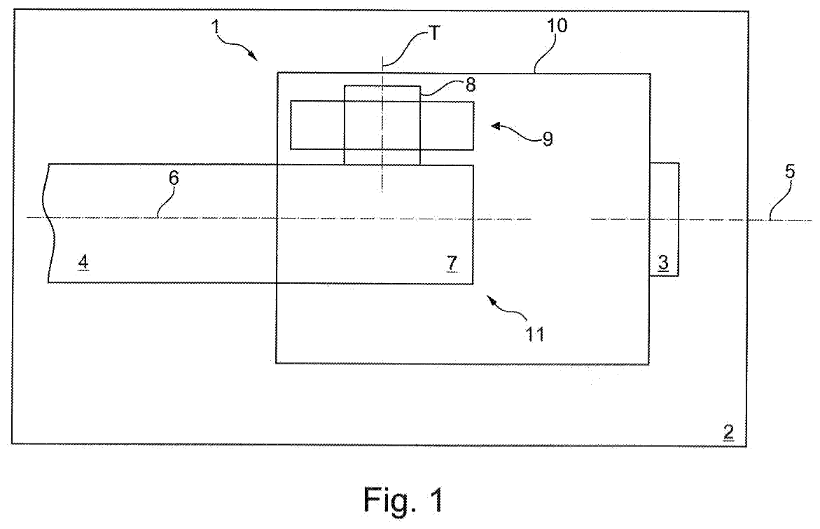

FIG. 1 shows in a highly schematic representation a constant velocity joint 1 for a vehicle 2, which is only shown as a block.

The constant velocity joint 1 is arranged in the drive train between a transmission output 3, in particular a differential, and an intermediate shaft 4, in particular a wheel drive shaft or an articulated shaft. The transmission output 3 defines an output axis 5, the intermediate shaft 4 defines a shaft axis 6. The constant velocity joint 1 is designed to transmit a rotation and thus a drive torque from the output 3 to the intermediate shaft 4 and at the same time to enable pivoting or a change in angle between the output axle 5 and the shaft axle 6, as is the case, for example, upon compression of the driven wheel, which is connected to the intermediate shaft 4. The intermediate shaft 4 has a stub shaft section 7, on which a plurality of pins 8, in this exemplary embodiment three pins 8, are arranged, which extend radially to the shaft axis 6. The pins 8 are evenly arranged in the circumferential direction around the shaft axis 6, so that they form a tripod star 11. Only one of the pins 8 is shown graphically in FIG. 1. A tripod roller 9 is arranged on each pin 8, and has a tripod roller axis T as the axis of rotation, which is arranged radially to the shaft axis 6.

The constant velocity joint 1 also has a bell section 10 which is non-rotatably coupled to the outlet 3 and which provides raceways for the tripod rollers 9.

While an exemplary embodiment is shown in FIG. 1, the bell section 10 being non-rotatably coupled to the output 3 and the stub shaft section 7 being non-rotatably coupled to the intermediate shaft 4, in other exemplary embodiments it is also possible for the stub shaft section 7 to be non-rotatably coupled to the output 3 and the bell section 10 to be coupled to the intermediate shaft 4. Furthermore, it is possible for the bell section 10 to be circumferentially closed or to have free areas.

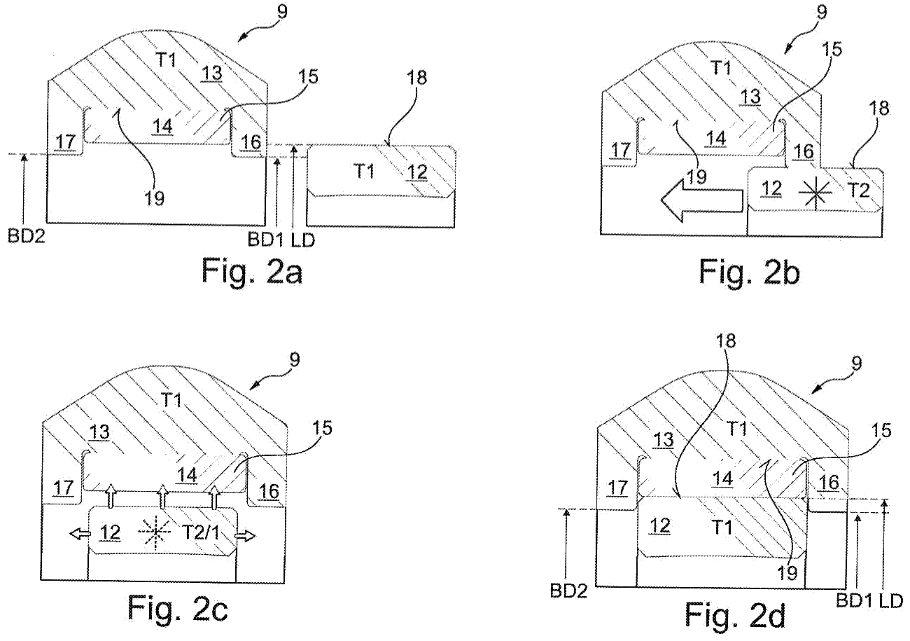

FIGS. 2a to 2d illustrate a method for assembling the tripod roller 9, as is used in the constant velocity joint 1 in FIG. 1. Each of the figures shows a longitudinal section of the tripod roller 9.

FIG. 2a shows the tripod roller 9 in a disassembled state, FIG. 2b shows the tripod roller 9 during the assembly process, FIG. 2c shows the tripod roller 9 after the assembly process at a temperature equalization and FIG. 2d shows the tripod roller 9 in an assembled state.

The tripod roller 9 has an inner ring 12 and an outer ring 13, which are arranged coaxially and concentrically to one another and have the tripod roller axis T as the axis of rotation. Inner ring 12 and outer ring 13 may each be referred to as running rings.

The outer ring 13 is partially circular, segment-shaped and/or spherical on the radial outer side thereof. The outer ring 13 has a first and a second flange 16, 17, the flanges 16, 17 extending radially inwards. The flanges 16, 17 are rectangular in the longitudinal section. The first flange 16 defines a first flange diameter BD1 due to the free opening cross-section thereof, the second flange 17 defines a second flange diameter BD2 due to the free opening cross-section thereof. The flanges 16, 17 are formed in one piece in the outer ring 13 and/or are produced from a common base material without separation. In the longitudinal section shown, the flanges 16, 17 are directed radially inward to the tripod roller axis T. The outer ring 13 is thus designed as a flange ring.

A plurality of rolling elements 14 are arranged between the inner ring 12 and the outer ring 13, the rolling elements 14 being designed as rollers, in particular cylindrical rollers or needles. The rolling elements 14 are arranged between the inner ring and the outer ring 12, 13 in a rolling element space 15, the rolling element space 15 being delimited in the radial direction on the one hand by an inner raceway 18 and on the other hand by an outer raceway 19. In the axial direction, the rolling element space 15 is delimited by the flanges 16, 17, which form a run-up for the rolling elements 14.

The inner ring 12 has the inner raceway 18 as the maximum outer diameter. In particular, the inner ring 12 is rectangular in the longitudinal section shown. The inner race 18 defines a raceway diameter LD from the inner ring 12.

In FIGS. 2a and 2d, the tripod roller 9 is shown in a uniform temperature state with the temperature T1. Temperature T1 can be, for example, an ambient temperature of 20° C. It should be emphasized in particular that the inner ring 12 and the outer ring 13 have the same temperature T1. In this temperature state, the first flange diameter BD1 and/or the second flange diameter BD2 is smaller than the raceway diameter LB. This structural relationship can also be referred to as an interference fit. It follows from FIG. 2d that the inner ring 12 is held in a captive and/or form-fitting manner in the axial direction by the flanges 16, 17. The inner ring 12 is thereby designed as a thrust ring. FIG. 2a shows that the inner ring 12 cannot be pushed into the outer ring 13 due to the interference fit. It can be seen from FIG. 2d that the tripod roller 9 cannot be disassembled.

The assembly is made possible in that a temperature difference between the inner ring and the outer ring 12, 13 is implemented during the assembly process, so that the inner ring 12 is reduced in size relative to the outer ring 13 due to a contraction. This is implemented in that the inner ring 12 is cooled from a temperature T1 to a lower temperature T2, for example with liquid nitrogen, and is inserted into the outer ring 13 in the cooled state at the temperature T2, The corresponding method is visualized by FIGS. 2b and 2c. By cooling the inner ring 12 to the temperature T2, it is reduced in size, so that the raceway diameter LD is smaller than the flange diameter BD1 or BD2. In this state, the inner ring 12 can be inserted into the outer ring 13. In the assembled state, as shown in FIG. 2c, the inner ring 12 is heated again, so that there is a transition from the temperature T2 to the temperature T1. Due to the heating, the inner ring 12 expands again, so that it finally reaches the original size thereof and is arranged in a form-fitting manner between the flanges 16, 17.

In the exemplary embodiment of the tripod roller 9 in FIGS. 2a-d, both flanges 16, 17 are formed symmetrically with the same flange diameter BD1 or BD2. This has the advantage that the assembly can be done from either axial side. Each of the flanges 16, 17 can thus be used as an assembly flange.

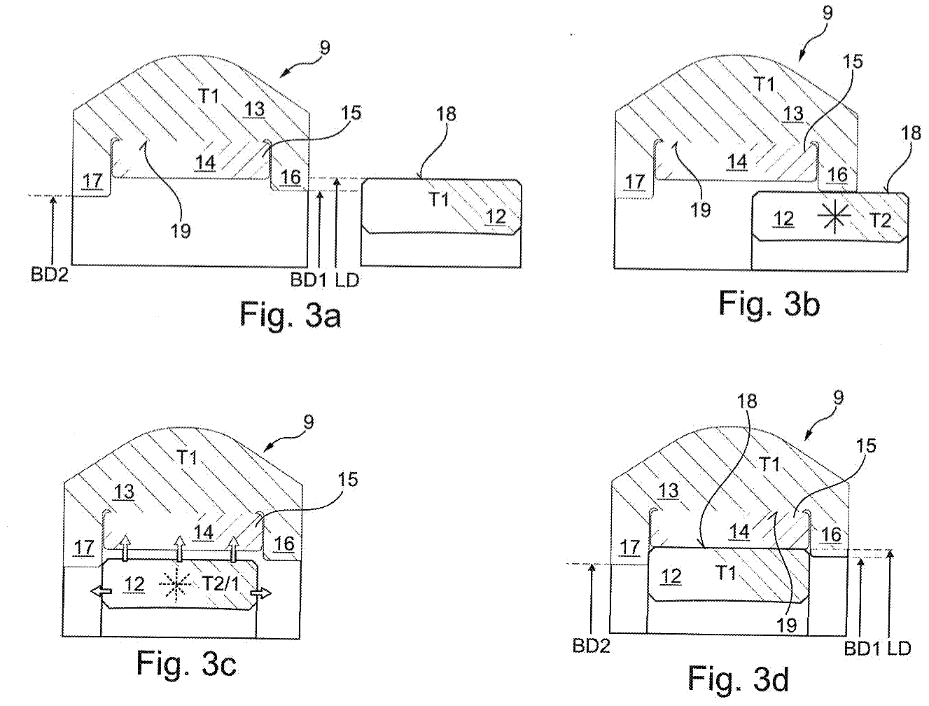

In FIGS. 3a-d, the flanges 16, 17 are designed with different flange diameters BD1 and BD2. The first flange 16 as an assembly flange has a larger flange diameter BD1 than the second flange 17, which is designed as a support flange. The assembly of the inner ring 12 is only possible from the side of the assembly flange. This embodiment has the disadvantage that the assembly can no longer be carried out from both axial sides. However, this embodiment has the advantage that the support flange can be made longer in the radial direction and can therefore transfer greater forces than the assembly flange. In the installation situation in the constant velocity joint 1, the tripod roller 9 is installed in such a way that the higher axial loads on the support flange are eliminated.

### LIST OF REFERENCE SYMBOLS

1 Constant velocity joint
2 Vehicle
3 Gear output
4 Intermediate shaft
5 Output axis
6 Shaft axis
7 Stub shaft section
8 Pin
9 Tripod roller
10 Articulated bell
11 Tripod star
12 Inner ring
13 Outer ring
14 Rolling elements
15 Rolling element space
16 First flange
17 Second flange
18 Inner raceway
19 Outdoor raceway

1. A method for assembling a tripod roller, the tripod roller comprising: an inner ring and an outer ring, the inner ring and the outer ring being designed as running rings, a plurality of rolling elements, the rolling elements being arranged in a rolling element space between the running rings, a first and a second flange, the flanges axially delimiting the rolling element space and/or forming an axial run-up for the rolling elements, the flanges in each case defining a flange diameter, the flanges being assigned to one of the running rings, so that this running ring forms a flange ring and the other running ring forms a thrust ring, a raceway for the rolling elements of the thrust ring defining a raceway diameter, the flanges being integrally formed on the flange ring and the raceway diameter overlaps both flange diameters such that the thrust ring between the flanges is kept captive in the axial direction, in the method the running rings being assembled one inside the other, the running rings having a temperature difference during the assembly process.

2. The method according to claim 1, wherein the temperature difference is greater than 100° C.

3. The method according to claim 1, wherein the inner ring is cooled or the outer ring is heated to produce the temperature difference.

4. A tripod roller having an inner ring and an outer ring, the inner ring and the outer ring being designed as running rings and having a plurality of rolling elements, the rolling elements being arranged in a rolling element space between the running rings, having a first and a second flange, the flanges axially delimiting the rolling element space the flanges each defining a flange diameter, the flanges being assigned to one of the running rings, so that this running ring forms a flange ring and the other running ring forms a thrust ring, the raceway of the thrust ring defining a raceway diameter wherein the flanges are integrally formed on the flange ring and the raceway diameter overlaps both flange diameters such that the running ring between the flanges is held captive in the axial direction.

5. The tripod roller according to claim 4, characterized in that the difference between the raceway diameter and at least one of the flange diameters is selected such that the running rings can be assembled if the running rings have a temperature difference.

6. The tripod roller according to claim 4, wherein one of the flanges is designed as a support flange and the other flange as an assembly flange, the difference between the raceway diameter and the flange diameter of the support flange being greater than the difference between the raceway diameter and the flange diameter of the assembly flange.

7. The tripod roller according to claim 4, wherein the flange ring is designed as the outer ring and the thrust ring is designed as the inner ring.

8. The tripod roller according to claim 4, wherein the inner ring is designed without a flange.

9. The tripod roller according to claim 4, wherein the inner ring is designed as a straight hollow cylinder.

10. A constant velocity joint comprising at least one tripod roller according to claim 4.

11. The method according to claim 1, wherein the temperature difference is greater than 150° C.

12. A method of assembling a constant velocity joint tripod roller, comprising:
providing an outer ring having two radially inward facing flanges, a first of the flanges having a nominal flange diameter at a nominal temperature and an assembly flange diameter at an outer ring assembly temperature;
providing an inner ring having an nominal outer diameter at the nominal temperature and an assembly outer diameter at an inner ring assembly temperature, the nominal outer diameter being greater than the nominal flange diameter and the assembly outer diameter being less than the assembly flange diameter;
adjusting a temperature of the outer ring to the outer ring assembly temperature;
adjusting a temperature of the tripod inner ring to the inner ring assembly temperature;
inserting a plurality of rollers between the flanges of the outer ring;
axially inserting the inner ring into the outer ring; and
adjusting the temperature of the outer ring and the temperature of the inner ring to the nominal temperature such that the inner ring is axially retained between the flanges.

13. The method of claim 12 wherein adjusting the temperature of the inner ring to the inner ring assembly temperature comprises cooling the inner ring.

14. The method of claim 12 wherein the nominal temperature is 20° C.

15. The method of claim 12 wherein the outer ring assembly temperature exceeds the inner ring assembly temperature by more than 100° C.

16. The method of claim 15 wherein the outer ring assembly temperature exceeds the inner ring assembly temperature by more than 150° C.
